(19) United States
(12) Patent Application Publication
(10) Pub. No.: US 2021/0137117 A1
(43) Pub. Date: May 13, 2021

(54) HERBICIDAL MIXTURES

(71) Applicant: Bayer Aktiengesellschaft, Leverkusen (DE)

(72) Inventors: Hubert MENNE, Mainz-Kastel (DE); Christoph BREITENSTROETER, Koeln (DE); Herve TOSSENS, Verlaine (BE)

(21) Appl. No.: 16/493,094

(22) PCT Filed: Mar. 22, 2018
(86) PCT No.: PCT/EP2018/057241

§ 371 Date: Sep. 11, 2019

(30) Foreign Application Priority Data
Mar. 24, 2017 (EP) 17162726.8

(51) Int. Cl. A01N 43/90; A01N 43/80

(52) U.S. Cl. CPC A01N 43/90; A01N 43/80

(57) ABSTRACT

The present invention relates to herbicidal mixtures comprising i) 2-[(2,4-dichlorophenyl)methyl]-4,4-dimethyl-3-isoxazolidinone and ii) cinmethylin, and to herbicidal compositions comprising these mixtures. Furthermore, the present invention relates to a process for preparing these herbicidal mixtures and compositions comprising these mixtures. Furthermore, the invention relates to the use of the mixtures and compositions mentioned in the field of agriculture for controlling harmful plants.

The present invention relates to herbicidal mixtures comprising i) 2-[(2,4-dichlorophenyl)methyl]-4,4-dimethyl-3-isoxazolidinone and ii) cinmethylin, and to herbicidal compositions comprising these mixtures. Furthermore, the present invention relates to a process for preparing these herbicidal mixtures and compositions comprising these mixtures. Furthermore, the invention relates to the use of the mixtures and compositions mentioned in the field of agriculture for controlling harmful plants.

2-[(2,4-Dichlorophenyl)methyl]-4,4-dimethyl-3-isoxazolidinone is already known as a selective herbicide from WO 2012/148689. Mixtures comprising this herbicide are known from WO 2015/127259.

WO 2017/009095, WO 2017/009124, WO 2017/009137, WO 2017/009138, WO 2017/009054, WO 2017/009056, WO 2017/009139, WO 2017/009140, WO 2017/009092, WO 2017009090, WO 2017/009134, WO 2017/009142, WO 2017/009143, WO 2017/009143 and WO 2017/009144 describe herbicidal mixtures comprising cinmethylin.

In spite of the good efficacy of 2-[(2,4-dichlorophenyl)methyl]-4,4-dimethyl-3-isoxazolidinone as individual active compound and in the mixtures already known, there is still a need for improving the application profile of this active compound. The reasons for this are diverse, for example a further increase of efficacy in specific areas of use, an increase of crop plant compatibility, a response to novel production techniques in individual crops and/or to the increased occurrence of herbicide-resistant harmful plants.

One way of improving the application profile of a herbicide may be to combine the active compound with one or more other suitable active compounds. However, in the combined application of a plurality of active compounds, there are frequently phenomena of chemical, physical and biological incompatibility, for example lack of stability of a coformulation, decomposition of an active compound and/or antagonism of the active compounds. What is desired, however, are combinations of active compounds having a favourable activity profile, high stability and ideally a synergistically enhanced activity which allows the application rate to be reduced compared to the individual application of the active compounds to be combined. Likewise desirable are combinations of active compounds which increase crop plant compatibility in general and/or can be used for specific production techniques. These include, for example, a reduction of sowing depth which, for crop compatibility reasons, can frequently not be used. In this manner, in general a more rapid emergence of the crop is achieved, their risk of emergence diseases (such as, for example, Pythium and Rhizoctonia) is reduced, and winter survival and stocking are improved. This also applies to late sowing which would otherwise not be possible owing to the crop compatibility risk.

It was an object of the present invention to improve the application profile of the herbicidally active compound 2-[(2,4-dichlorophenyl)methyl]-4,4-dimethyl-3-isoxazolidinone with respect to:
a more simple application method which would reduce the costs for the user and thus be more environmentally compatible;
an improvement in application flexibility of the active compounds from pre-emergence to post-emergence of the crop and weed plants;
an improvement of the application flexibility of the active compounds which would allow application prior to sowing of the crop;
an improvement and application flexibility of the reliability of action on soils with different soil properties (e.g. soil type, soil humidity);
an improvement and application flexibility of the reliability of action with different irrigation conditions (rain events);
an improvement of the reliability of action on weed plants germinating from different soil depths;
an improvement and application flexibility on soils of different pH;
an improvement of the reliability of action on resistant weed plant species which would allow a novel option for an effective resistance management.
an improvement of activity owing to synergism,

where the object mentioned last was of particular importance.

This object was achieved by providing a herbicide mixture comprising 2-[(2,4-dichlorophenyl)methyl]-4,4-dimethyl-3-isoxazolidinone and the further herbicide cinmethylin.

Accordingly, the invention provides herbicide mixtures comprising
i) 2-[(2,4-dichlorophenyl)methyl]-4,4-dimethyl-3-isoxazolidinone

[chemical structure]

and
ii) cinmethylin.

A further aspect of the present invention is a herbicide mixture comprising, in addition to components i) and ii), at least one further herbicide of group I.

A further aspect of the present invention is a herbicide mixture comprising, in addition to components i) and ii), at least one safener.

A further aspect of the present invention is a herbicide mixture comprising, in addition to components i) and ii), at least one further herbicide of group I and a safener.

### Definitions

Herbicides of group I:

acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-6-(4-chloro-2-fluoro-3-methylphenyl)-5-fluoropyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, chlorsulfuron, cinidon, cinidon-ethyl, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyrimorate, cyclosulfamuron, cycloxydim, cyhalofop, cyhalofop-butyl, cyprazine, 2,4-D, 2,4-D-butotyl, -butyl, -dimethylammonium, -diolamine, -ethyl, -2-ethylhexyl, -isobutyl, -isooctyl, -isopropylammonium, -potassium, -triisopropanolammonium and -trolamine, 2,4-DB, 2,4-DB-butyl, -dimethylammonium, -isooctyl, -potassium and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, dimetrasulfuron, dinitramine, dinoterb, diphenamid, diquat, diquat dibromide, dithiopyr, diuron, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, F-5231, i.e. N-[2-chloro-4-fluoro-5-[4-(3-fluoropropyl)-4,5-dihydro-5-oxo-1H-tetrazol-1-yl]phenyl]ethansulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium and -trimesium, H-9201, i.e. O-(2,4-dimethyl-6-nitrophenyl)O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium and -sodium, MCPB, MCPB-methyl, -ethyl and -sodium, mecoprop, mecoprop-sodium and -butotyl, mecoprop-P, mecoprop-P-butotyl, -dimethylammonium, -2-ethylhexyl and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinate, monolinuron, monosulfuron, monosulfuron-ester, MT-5950, i.e. N-[3-chloro-4-(1-methylethyl)phenyl]-2-methylpentanamide, NGGC-011, napropamide, NC-310, i.e. 4-(2,4-dichlorobenzoyl)-1-methyl-5-benzyloxypyrazole, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate. SYP-300. i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trifluoroacetic acid), TCA-sodium, tebuthiuron, tefuryltrione, tembotrione, tepraloxydim, terbacil, terbucarb, terbumeton, terbuthylazin, terbutryn, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, XDE-848, ZJ-0862, i.e. 3,4-dichloro-N-{2-[(4,6-dimethoxypyrimidin-2-yl)oxy]benzyl}aniline, and also the following compounds:

[chemical structure]

Examples of plant growth regulators as possible mixing partners are:

acibenzolar, acibenzolar-S-methyl, 5-aminolevulinic acid, ancymidol, 6-benzylaminopurine, brassinolide, catechol, chlormequat chloride, cloprop, cyclanilide, 3-(cycloprop-1-enyl)propionic acid, daminozide, dazomet, n-decanol, dikegulac, dikegulac-sodium, endothal, endothal-dipotassium, -disodium, and mono(N,N-dimethylalkylammonium), ethephon, flumetralin, flurenol, flurenol-butyl, flurprimidol, forchlorfenuron, gibberellic acid, inabenfide, indole-3-acetic acid (IAA), 4-indol-3-ylbutyric acid, isoprothiolane, probenazole, jasmonic acid, jasmonic acid methyl ester, maleic hydrazide, mepiquat chloride, 1-methylcyclopropene, 2-(1-naphthyl)acetamide, 1-naphthylacetic acid, 2-naphthyloxyacetic acid, nitrophenoxide mixture, 4-oxo-4-[(2-phenylethyl)amino]butyric acid, paclobutrazole, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

Herbizides:

The herbicides mentioned in the present description are known, for example, from “The Pesticide Manual”, 16th edition 2012.

Safeners:

Examples of useful safeners include the following groups of compounds:
S1) Compounds from the group of heterocyclic carboxylic acid derivatives:
S1^{a}) Compounds of the dichlorophenylpyrazoline-3-carboxylic acid type (S1^{a}), preferably compounds such as
   1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;
S1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;
S1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds as described, for example, in EP-A-268554;
S1^{d}) Compounds of the triazolecarboxylic acid type (S1^{d}), preferably compounds such as fenchlorazole (ethyl ester), i.e. ethyl 1-(2,4-dichlorophenyl)-5-trichloromethyl-H-1,2,4-triazole-3-carboxylate (S1-7), and related compounds, as described in EP-A-174 562 and EP-A-346 620;
S1^{e}) Compounds of the 5-benzyl- or 5-phenyl-2-isoxazoline-3-carboxylic acid or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-arboxylate (S1-12) or ethyl 5-(4-fluorophenyl)-5-phenyl-2-isoxazoline-3-carboxylate (S1-13), as described in patent application WO-A-95/07897.
S2) Compounds from the group of the 8-quinolinoxy derivatives (S2):
S2^{a}) Compounds of the 8-quinolinoxyacetic acid type (S2^{a}), preferably 1-methylhexyl (5-chloro-8-quinolinoxy)acetate (“cloquintocet-mexyl”) (52-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminium, iron, ammonium, quaternary ammonium, sulfonium or phosphonium salts thereof, as described in WO-A-2002/34048;
S2^{b}) Compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
S3) Active compounds of the dichloroacetamide type (S3), which are frequently used as pre-emergence safeners (soil-acting safeners), for example “dichlormid” (N,N-diallyl-2,2-dichloroacetamide) (S3-1), “R-29148” (3-dichloroacetyl-2,2,5-trimethyl-1,3-oxazolidine) from Stauffer (S3-2), “R-28725” (3-dichloroacetyl-2,2-dimethyl-1,3-oxazolidine) from Stauffer (S3-3), “benoxacor” (4-dichloroacetyl-3,4-dihydro-3-methyl-2H-1,4-benzoxazine) (S3-4), “PPG-1292” (N-allyl-N-[(1,3-dioxolan-2-yl)methyl]dichloroacetamide) from PPG Industries (S3-5), “DKA-24” (N-allyl-N-[(allylaminocarbonyl)methyl]dichloroacetamide) from Sagro-Chem (S3-6), “AD-67” or “MON 4660” (3-dichloroacetyl-1-oxa-3-azaspiro[4.5]decane) from Nitrokemia or Monsanto (S3-7), “TI-35” (1-dichloroacetylazepane) from TRI-Chemical RT (S3-8), “diclonon” (dicyclonon) or “BAS145138” or “LAB145138” (S3-9) ((RS)-1-dichloroacetyl-3,3,8a-trimethylperhydropyrrolo[12-a]pyrimidin-6-one) from BASF, “furilazole” or “MON 13900” ((RS)-3-dichloroacetyl-5-(2-furyl)-2,2-dimethyloxazolidine) (S3-10), and the (R) isomer thereof (S3-11).
S4) Compounds from the class of the acylsulfonamides (S4):
S4^{a}) N-Acylsulfonamides of the formula (S4^{a}) and salts thereof, as described in WO-A-97/45016,

[chemical structure]

in which
R_{A}¹ represents (C₁-C₆)-alkyl. (CC)-cycloalkyl, where the 2 latter radicals are substituted by v_{A} substituents from the group of halogen, (C₁-C₄)-alkoxy, (C₁-C₆)-haloalkoxy and (C₁-C₄)-alkylthio and, in the case of cyclic radicals, also by (C₁-C₄)-alkyl and (C₁-C₄)-haloalkyl;
R_{A}² represents halogen, (C₁-C₄)-alkyl. (C₁-C₄)-alkoxy. CF₃;
m_{A} represents 1 or 2;
v_{A} represents 0, 1.2 or 3;
S4^{b}) Compounds of the 4-(benzoylsulfamoyl)benzamide type of the formula (S4^{b}) and salts thereof, as described in WO-A-99/16744.

[chemical structure]

in which
R_{B}¹, R_{B}² independently of one another represent hydrogen, (C₁-C₆)-alkyl, (C₃—C)-cycloalkyl, (C₃-C₆)-alkenyl. (C₁-C₆)-alkynyl,
R_{B}¹ represents halogen. (C₁-C₄)-alkyl, (C₁-C₄)-haloalkyl or (C₁-C₄)-alkoxy and
m_{B} represents 1 or 2.
for example those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B})=5-Cl-2-OMe (S4-4) and
R_{B}¹=isopropyl, R_{B}²=hydrogen and (R)=2-OMe (S4-5);
S4^{c}) Compounds from the class of the benzoylsulfamoylphenylureas of the formula (S4^{c}), as described in EP-A-365484,

[chemical structure]

in which
R_{C}¹, R_{C}² are independently hydrogen, (C₁-C₈)-alkyl, (C₃-C₈)-cycloalkyl, (C₃-C₆)-alkenyl, (C₃-C₆)-alkynyl,
R_{C}³ represents halogen, (C₁-C₄)-alkyl, (C₁-C₄)-alkoxy, CF₃ and
m_{C} represents 1 or 2;
for example
1-[4-(N-2-methoxybenzoylsulfamoyl)phenyl]-3-methylurea,
1-[4-(N-2-methoxy benzoylsulfamoyl)phenyl]-3,3-dimethylurea,
1-[4-(N-4,5-dimethylbenzoylsulfamoyl)phenyl]-3-methylurea;
S4^{d}) Compounds of the N-phenylsulfonylterephthalamide type of the formula (S4^{d}) and salts thereof, which are known, for example, from CN 101838227,

[chemical structure]

in which
R_{D}⁴ represents halogen, (C₁-C₄)-alkyl, (C₁-C₄)-alkoxy, CF₃;
m_{D} represents 1 or 2;
R_{D}⁵ represents hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
S5) Active compounds from the class of the hydroxyaromatics and the aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
S6) Active compounds from the class of the 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.
S7) Compounds from the class of the diphenylmethoxyacetic acid derivatives (S7), e.g. methyl diphenylmethoxyacetate (CAS Reg. No. 41858-19-9) (S7-1), ethyl diphenylmethoxyacetate or diphenylmethoxyacetic acid, as described in WO-A-9838856.
S8) Compounds of the formula (S8), as described in WO-A-98/27049.

[chemical structure]

in which the symbols and indices are defined as follows:
R_{D}¹ represents halogen. (C₁-C₄)-alkyl, (C₁-C₄)-haloalkyl, (C₁-C₄)-alkoxy, (C₁-C₄)-haloalkoxy,
R_{D}² represents hydrogen or (C₁-C₄)-alkyl,
R_{D}³ represents hydrogen, (C₁-C₈)-alkyl, (C₂-C₄)-alkenyl, (C₂-C₄)-alkynyl or aryl, where each of the aforementioned carbon-containing radicals is unsubstituted or substituted by one or more, preferably up to three, identical or different radicals from the group consisting of halogen and alkoxy; or salts thereof,
n_{D} represents an integer from 0 to 2.
S9) Active compounds from the class of the 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No. 219479-18-2), 1,2-dihydro-4-hydroxy-1-methyl-3-(5-tetrazolylcarbonyl)-2-quinolone (CAS Reg. no. 95855-00-8), as described in WO-A-1999/000020;
S10) Compounds of the formula (S10) or (S10) as described in WO-A-2007/023719 and WO-A-2007/023764

[chemical structure]

in which
R_{E}¹ represents halogen, (C₁-C₄)-alkyl, methoxy, nitro, cyano, CF₃, OCF₃,
Y_{E}, Z_{E} independently of one another represent O or S.
n_{E} represents an integer from 0 to 4,
R_{E}² represents (C₁-C₆)-alkyl, (C₂-C₆)-alkenyl, (C₃-C₆)-cycloalkyl, aryl; benzyl, halobenzyl.
R_{E}³ represents hydrogen or (C₁-C₆)-alkyl.
S11) Active compounds of the oxyimino compound type (S11), which are known as seed-dressing compositions, for example “oxabetrinil” ((Z)-1,3-dioxolan-2-yl-methoxyimino(phenyl)acetonitrile) (S1-), which is known as a seed-dressing safener for millet/sorghum against metolachlor damage,
   “fluxofenim” (1-(4-chlorophenyl)-2,2,2-trifluoro-1-ethanone O-(1,3-dioxolan-2-ylmethyl)oxime) (S11-2), which is known as a seed-dressing safener for millet/sorghum against metolachlor damage, and
   “cyometrinil” or “CGA-43089” ((Z)-cyanomethoxyimino(phenyl)acetonitrile) (S11-3), which is known as a seed-dressing safener for millet/sorghum against metolachlor damage.
S12) Active compounds from the class of the isothiochromanones (S12), for example methyl [(3-oxo-1H-2-benzothiopyran-4(3H)-ylidene)methoxy]acetate (CAS Reg. No. 205121-(4-6) (S12-1) and related compounds from WO-A-1998/13361.
S13) One or more compounds from group (S13):
   “naphthalic anhydride” (1,8-naphthalenedicarboxylic anhydride) (S13-1), which is known as a seed-dressing safener for maize against thiocarbamate herbicide damage,
   “fenclorim” (4,6-dichloro-2-phenylpyrimidine) (S13-2), which is known as a safener for pretilachlor in sown rice,
   “flurazole” (benzyl 2-chloro-4-trifluoromethyl-1,3-thiazole-5-carboxylate) (S13-3), which is known as a seed-dressing safener for millet/sorghum against alachlor and metolachlor damage,
   “CL 304415” (CAS Reg. No. 31541-57-8) (4-carboxy-3,4-dihydro-2H-1-benzopyran-4-acetic acid) (S13-4) from American Cyanamid, which is known as a safener for maize against damage by imidazolinones.
   “MG 191” (CAS Reg. No. 96420-72-3) (2-dichloromethyl-2-methyl-1,3-dioxolane) (S13-5) from Nitrokemia, which is known as a safener for maize,
   “MG 838” (CAS Reg. No. 133993-74-5) (2-propenyl 1-oxa-4-azaspiro[4.5]decane-4-carbodithioate) (513-6) from Nitrokemia,
   “disulfoton” (O,O-diethyl S-2-ethylthioethyl phosphorodithioate) (S13-7),
   “dietholate” (O,O-diethyl O-phenyl phosphorothioate) (513-8),
   “mephenate” (4-chlorophenyl methylcarbamate) (S13-9).
S14) Active compounds which, in addition to herbicidal action against harmful plants, also have safener action on crop plants such as rice, for example
   “dimepiperate” or “MY-93” (S-1-methyl-1-phenylethylpiperidine-1-carbothioate), which is known as a safener for rice against damage by the herbicide molinate.
   “daimuron” or “SK 23” (1-(1-methyl-1-phenylethyl)-3-p-tolylurea), which is known as a safener for rice against imazosulfuron herbicide damage,
   “cumyluron”=“JC-940” (3-(2-chlorophenylmethyl)-1-(1-methyl-1-phenylethyl)urea, see JP-A-60087254), which is known as a safener for rice against damage by some herbicides,
   “methoxyphenone” or “NK 049” (3,3′-dimethyl-4-methoxybenzophenone), which is known as a safener for rice against damage by some herbicides,
   “CSB” (1-bromo-4-(chloromethylsulfonyl)benzene) from Kumiai, (CAS Reg. No. 54091-06-4), which is known as a safener against damage by some herbicides in rice.
S15) Compounds of the formula (S15) or tautomers thereof

[chemical structure]

as described in WO-A-200&/131861 and WO-A-2008/131860,
in which
R_{H}¹ represents a (C₁-C₆)-haloalkyl radical and
R₁₂ represents hydrogen or halogen and
R_{H}³, R_{H}⁴ independently of one another represent hydrogen. (C₁-C₁₆)-alkyl, (C₂-C₁₆)-alkenyl or (C₂-C₁₆)-alkynyl,
   where each of the 3 latter radicals is unsubstituted or substituted by one or more radicals from the group of halogen, hydroxyl, cyano, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or (C₁-C₆)-cycloalkyl, (C₄-C₆)-cycloalkenyl, (C₁-C₆)-cycloalkyl fused on one side of the ring to a 4 to 6-membered saturated or unsaturated carbocyclic ring, or (C₄-C₆)-cycloalkenyl fused on one side of the ring to a 4 to 6-membered saturated or unsaturated carbocyclic ring,
   where each of the 4 latter radicals is unsubstituted or substituted by one or more radicals from the group of halogen, hydroxyl, cyano. (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di[(C₁-C₄)alkyl]amino. [(C₁-C₄)alkoxy]carbonyl, [(C₁-C₄)haloalkoxy]carbonyl, (C₃-C₆)-cycloalkyl which is unsubstituted or substituted, phenyl which is unsubstituted or substituted, and heterocyclyl which is unsubstituted or substituted,
   or
R_{H}³ represents (C₁-C₄)-alkoxy, (C₁-C₄)-alkenyloxy, (C₂-C₆)-alkynyloxy or (C₂-C₄)-haloalkoxy and
R_{H}⁴ represents hydrogen or (C₁-C₄)-alkyl or
R_{H}³ and R_{H}⁴ together with the directly attached nitrogen atom represent a four- to eight-membered heterocyclic ring which, as well as the nitrogen atom, may also contain further ring heteroatoms, preferably up to two further ring heteroatoms from the group of N, O and S, and which is unsubstituted or substituted by one or more radicals from the group of halogen, cyano, nitro. (C₁-C₄)-alkyl, (C₁-C₄)-haloalkyl, (C₁-C₄)-alkoxy, (C₁-C₄)-haloalkoxy and (C₁-C₄)-alkylthio.
S16) Active compounds which are used primarily as herbicides but also have safener action on crop plants, for example (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor-ethyl).

Preferred safeners are: cloquintocet-mexyl, cyprosulfamide, fenchlorazole-ethyl, isoxadifen-ethyl, mefenpyr-diethyl, fenclorim, cumyluron.

Particularly preferred safeners are: cloquintocet-mexyl, cyprosulfamide, isoxadifen-ethyl and mefenpyr-diethyl.

Very particular preference is given to: mefenpyr-diethyl.

AS/ha:

If the abbreviation “AS/ha” is used in the present description, it means “active substance per hectare” based on 100% active compound. All percentages in the description are percent by weight (abbreviation: “% by weight”) and, unless defined otherwise, refer to the relative weight of the respective component based on the total weight of the herbicidal mixture/composition (for example as formulation).

Cinmethylin (CAS RN 87818-31-3) is a racemic mixture of (+/−)-2-exo-(2-methylbenzyloxy)-1-methyl-4-isopropyl-7-oxabicyclo[2.2.1]heptane.

[chemical structure]

Here, the ratio of the two enantiomers is about even. The preparation of the enantiomerically enriched compounds is known from EP 0 081 893 A2.

The herbicidal compositions according to the invention comprise the components according to the invention of the mixture i), ii) and optionally further herbicides and safeners and contain further components, e.g. agrochemically active compounds from the group of the insecticides and fungicides and/or additives and/or formulation auxiliaries customary in crop protection.

In a preferred embodiment, the herbicidal mixtures/compositions according to the invention have, as an improvement of the application profile, synergistic effects. These synergistic effects can be observed, for example, when applying the herbicide components together; however, they can frequently also be observed when the components are applied at different times (splitting). It is also possible to apply the individual herbicides or the herbicide combinations in a plurality of portions (sequential application), for example pre-emergence applications followed by post-emergence applications or early post-emergence applications followed by medium or late post-emergence applications. Preference is given here to the joint or almost simultaneous application of the active compounds of the herbicidal mixtures/compositions according to the invention.

The synergistic effects permit a reduction of the application rates of the individual active compounds, a higher efficacy at the same application rate, the control of species which are as yet uncovered (gaps), an extension of the period of application and/or a reduction in the number of individual applications required and—as a result for the user—weed control systems which are more advantageous economically and ecologically.

The application rate of the herbicide components in the herbicidal mixtures/compositions may vary within wide ranges. Applied at application rates of from 1 to 5000 g of AS/ha by the pre- and post-emergence method, the herbicide components control a relatively broad spectrum of annual and perennial broad-leaved weeds, weed grasses and Cyperaceae.

The application rates of the herbicide components in the mixtures/compositions are, with respect to one another, in the weight ratio stated below:
i): ii)
in general (1-1000):(1-1000), preferably (1-100):(1-100), particularly preferably (1-50):(1-50).

The application rates of the respective herbicide components in the herbicidal mixtures/compositions are:
component i): in general 1-2000 g of AS/ha, preferably 10-1000 g of AS/ha, particularly preferably 10-500 g of AS/ha of 2-[(2,4-dichlorophenyl)methyl]-4,4-dimethyl-3-isoxazolidinone;
component ii): in general 1-2000 g of AS/ha, preferably 10-1000 g of AS/ha, particularly preferably 10-500 g of AS/ha of cinmethylin.

If the composition contains a safener, the application rate is in general 5-2000 g of AS/ha, preferably 10-500 g of AS/ha and particularly preferably 10-300 g of AS/ha.

Correspondingly, the application rates mentioned above may be used to calculate the percentages by weight (% by weight) of the herbicide components based on the total weight of the herbicidal compositions, which may additionally also comprise other components.

The mixtures/compositions according to the invention have excellent herbicidal efficacy against a broad spectrum of economically important mono- and dicotyledonous annual harmful plants. The active compounds also act efficiently on perennial weeds which produce shoots from rhizomes, root stocks and other perennial organs and which are difficult to control.

The present invention therefore also provides a method for controlling unwanted plants or for regulating the growth of plants, preferably in plant crops, in which the mixtures/compositions according to the invention are applied to the plants (for example harmful plants such as monocotyledonous or dicotyledonous weeds or unwanted crop plants), the seed (for example grains, seeds or vegetative propagules such as tubers or shoot parts with buds) or the area on which the plants grow (for example the area under cultivation). The mixtures/compositions according to the invention can be deployed, for example, prior to sowing (if appropriate also by incorporation into the soil), prior to emergence or after emergence. Specific examples of some representatives of the monocotyledonous and dicotyledonous weed flora which can be controlled by the mixtures/compositions of the invention are as follows, though the enumeration is not intended to impose a restriction to particular species.

Monocotyledonous harmful plants of the genera: Aegilops, Agropyron, Agrostis, Alopecurus, Apera, Avena, Brachiaria, Bromus, Cenchrus, Commelina, Cynodon, Cyperus, Dactyloctenium, Digaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria and Sorghum.

Dicotyledonous weeds of the genera: Abudlon, Amaranthus, Ambrosia, Anoda, Anthemis, Aphanes, Artemisia, Atriplex, Bellis, Bidens, Capsella, Carduus, Cassia, Centaurea, Chenopodium, Cirsium, Convolvuus, Datum, Desmodiun, Emex, Erysimum, Euphorbia, Galeopsis, Galinsoga, Galin, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola and Xanthium.

If the mixtures/compositions according to the invention are applied to the soil surface before germination, either the emergence of the weed seedlings is prevented completely or the weeds grow until they have reached the cotyledon stage, but then they stop growing and ultimately die completely after three to four weeks have passed. This is also the case when the IBS (Incorporated By Sowing) application method is used. Here, the herbicidal mixture/composition is introduced into the seed bed during sowing.

If the mixtures/compositions according to the invention are applied post-emergence to the green parts of the plants, growth stops after the treatment, and the harmful plants remain at the growth stage at the time of application, or they die completely after a certain time, such that competition by the weeds, which is harmful to the crop plants, is thus eliminated very early and in a lasting manner. In the case of rice, the mixtures/compositions according to the invention can also be applied into the water, and they are then taken up via soil, shoot and roots.

The mixtures/compositions according to the invention are distinguished by a rapidly commencing and long-lasting herbicidal action. In general, the rainfastness of the active compounds in the mixtures/compositions according to the invention is favourable. A particular advantage is that the effective dosages of components i) and ii) used in the mixtures/compositions according to the invention can be adjusted to such a low level that their soil action is optimally low. This does not only allow them to be employed in sensitive crops in the first place, but ground water contaminations are also virtually avoided.

The combination according to the invention of active compounds allows the required application rate of the active compounds to be reduced considerably.

When the components i) and ii) are applied jointly in the mixtures/compositions according to the invention, there are, in a preferred embodiment, as improvement of the application profile, superadditive (=synergistic) effects. Here, the activity in the combinations is higher than the expected sum of the activities of the individual herbicides employed. The synergistic effects allow higher efficacy and/or longer persistency; the control of a wider spectrum of broad-leaved weeds, weed grasses and Cyperaceae, in some cases with only one or a few applications; a more rapid onset of the herbicidal action; the control of species which are as yet uncovered (gaps); the control of, for example, species which are tolerant or resistant to individual herbicides or to a number of herbicides; an extension of the period of application and/or a reduction in the number of individual applications required or a reduction of the total application rate and—as a result for the user—weed control systems which are more advantageous economically and ecologically.

The abovementioned properties and advantages are necessary for practical weed control to keep agricultural/forestry/horticultural crops, green land/meadows or crops for generating energy (biogas, bioethanol) free of unwanted competing plants, and thus to ensure and/or increase yield levels from the qualitative and quantitative angles. These novel combinations in the herbicidal mixtures/compositions according to the invention markedly exceed the technical state of the art with a view to the properties described.

Although the mixtures/compositions of the invention have outstanding herbicidal activity against monocotyledonous and dicotyledonous weeds, crop plants of economically important crops, for example dicotyledonous crops of the genera Arachis, Beta, Brassica, Cucumis, Cucurbita, Helianthus, Daucus, Glycine, Gossypium, Ipomoea, Lactuca, Linum, Lycopersicon, Miscanthus, Nicotiana, Phaseolus, Pisum, Solanum, Vicia, or monocotyledonous crops of the genera Allium, Ananas, Asparagus, Avena, Hordeum, Oryza, Panicum, Saccharum. Secale, Sorghum, Triticale, Triticum, Zea, in particular Zea and Triticum, will be damaged to a negligible extent only, if at all, depending on the structure of the particular compound of the invention and its application rate.

Furthermore, some of the mixtures/compositions according to the invention can have growth-regulating properties with respect to the crop plants. They intervene in the plants' own metabolism with regulatory effect, and can thus be used for the controlled influencing of plant constituents and to facilitate harvesting, for example by triggering desiccation and stunted growth. Furthermore, they are also suitable for the general control and inhibition of unwanted vegetative growth without killing the plants in the process.

Inhibition of vegetative growth is very important for many mono- and dicotyledonous crops, since this can reduce or completely prevent harvesting losses caused by lodging.

Owing to their improved application profile, the mixtures/compositions according to the invention can also be employed for controlling harmful plants in known plant crops or in tolerant or genetically modified crop and energy plants still to be developed. In general, transgenic plants (GMOs) are characterized by particular advantageous properties, for example by resistances to certain pesticides, in particular certain herbicides (such as resistances against components i) and ii) in the mixtures/compositions according to the invention), for example by resistances to harmful insects, plant diseases or pathogens of plant diseases, such as certain microorganisms such as fungi, bacteria or viruses. Other specific characteristics relate, for example, to the harvested material with regard to quantity, quality, storability, and the composition of specific constituents. Thus, transgenic plants are known whose starch content is increased, or whose starch quality is altered, or those where the harvested material has a different fatty acid composition, or increased vitamin content or energetic properties. Further special properties may be tolerance or resistance to abiotic stressors, for example heat, cold, drought, salinity and ultraviolet radiation. In the same manner, owing to their herbicidal and other properties, the mixtures/compositions according to the invention can also be used for controlling harmful plants in crops of known plants or plants still to be developed by mutant selection, and also crossbreeds of mutagenic and transgenic plants.

Conventional ways of producing novel plants which have modified properties in comparison to existing plants consist, for example, in traditional cultivation methods and the generation of mutants. Alternatively, novel plants with altered properties can be generated with the aid of recombinant methods (see, for example, EP 0221044 A, EP 0131624 A). For example, in several cases the following have been described: genetic modifications of crop plants for the purpose of modifying the starch synthesized in the plants (for example WO 92/011376 A, WO 92/014827 A, WO 91/019806 A); transgenic crop plants which are resistant to certain herbicides of the glufosinate type (cf., for example, EP 0242236 A, EP 0242246 A) or glyphosate (WO 92/000377 A) or of the sulfonylurea type (EP 0257993 A, U.S. Pat. No. 5,013,659) or to combinations or mixtures of these herbicides through “gene stacking”, such as transgenic crop plants e.g. corn or soybean with the tradename or the name Optimum™ GAT™ (glyphosate ALS tolerant); transgenic crop plants, for example cotton, with the capability of producing Bacillus thuringiensis toxins (Bt toxins) which make the plants resistant to certain pests (EP 0142924 A, EP 0193259 A); transgenic crop plants having a modified fatty acid composition (WO 91/013972 A); genetically modified crop plants having novel constituents or secondary compounds, for example novel phytoalexins providing increased resistance to disease (EP 0309862 A. EP 0464461 A); genetically modified plants having reduced photorespiration, which provide higher yields and have higher stress tolerance (EP 0305398 A); transgenic crop plants producing pharmaceutically or diagnostically important proteins (“molecular pharming”); transgenic crop plants distinguished by higher yields or better quality; transgenic crop plants distinguished by a combination, for example of the novel properties mentioned above (“gene stacking”).

Numerous molecular biology techniques which can be used to produce novel transgenic plants with modified properties are known in principle; see, for example, I. Potrykus and G. Spangenberg (eds), Gene Transfer to Plants, Springer Lab Manual (1995). Springer Verlag Berlin. Heidelberg or Christou. “Trends in Plant Science” 1(1996) 423-431). For such genetic manipulations, nucleic acid molecules which allow mutagenesis or sequence alteration by recombination of DNA sequences can be introduced into plasmids. With the aid of standard methods, it is possible, for example, to undertake base exchanges, remove part sequences or add natural or synthetic sequences. To join the DNA fragments with one another, adapters or linkers can be placed onto the fragments, see, for example, Sambrook et al., 1989, Molecular Cloning. A Laboratory Manual, 2nd edition Cold Spring Harbor Laboratory Press, Cold Spring Harbor, N.Y.; or Winnacker “Gene und Klone” [Genes and clones], VCH Weinheim 2nd edition 1996.

For example, the generation of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product.

To this end, it is firstly possible to use DNA molecules which encompass the entire coding sequence of a gene product inclusive of any flanking sequences which may be present, and also DNA molecules which only encompass portions of the coding sequence, in which case it is necessary for these portions to be long enough to have an antisense effect in the cells. It is also possible to use DNA sequences which have a high degree of homology to the coding sequences of a gene product, but are not completely identical.

When expressing nucleic acid molecules in plants, the protein synthesized may be localized in any desired compartment of the plant cell. However, to achieve localization in a particular compartment, it is possible, for example, to join the coding region to DNA sequences which ensure localization in a particular compartment. Such sequences are known to those skilled in the art (see, for example. Braun et al., EMBO J. 1(1992), 3219-3227; Wolter et al., Proc. Nat. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give rise to entire plants. In principle, the transgenic plants may be plants of any desired plant species, i.e. not only monocotyledonous but also dicotyledonous plants. Thus, transgenic plants can be obtained whose properties are altered by overexpression, suppression or inhibition of homologous (=natural) genes or gene sequences or expression of heterologous (=foreign) genes or gene sequences.

The present invention furthermore also provides a method for controlling unwanted vegetation (for example harmful plants), preferably in crop plants such as cereals (for example durum wheat and common wheat, barley, rye, oats, crossbreeds thereof such as triticale, planted or sown rice under ‘upland’ or ‘paddy’ conditions, corn, millet such as, for example, sorghum), sugar beet, sugar cane, oilseed rape, cotton, sunflowers, soybeans, potatoes, tomatoes, beans such as, for example, bush beans and broad beans, flax, pasture grass, fruit plantations, plantation crops, greens and lawns, and also squares of residential areas and industrial sites, rail tracks, particularly preferably in monocotyledonous crops such as cereals, for example wheat, barley, rye, oats, crossbreeds thereof such as triticale, rice, corn and millet and also dicotyledonous crops such as sunflowers, soybeans, potatoes, tomatoes, peas, carrots and fennel where the components i) and ii) of the herbicidal compositions according to the invention are applied jointly or separately to the plants, for example harmful plants, plant parts, plant seeds or the area on which the plants grow, for example the area under cultivation, for example by the pre-emergence method (very early to late), post-emergence method or pre-emergence and post-emergence method.

The invention also provides the use of the herbicidal compositions according to the invention comprising the components i) and ii) for controlling harmful plants, preferably in crop plants, preferably in the crop plants mentioned above. The invention also provides the use of the herbicidal compositions according to the invention comprising the components i) and ii) for controlling herbicide-resistant harmful plants (for example TSR and EMR resistances in the case of ALS and ACCase), preferably in crop plants, preferably in the crop plants mentioned above.

The invention also provides the method with the herbicidal compositions according to the invention comprising the components i) and ii) for the selective control of harmful plants in crop plants, preferably in the crop plants mentioned above, and its use.

The invention also provides the method for controlling unwanted vegetation with the herbicidal compositions according to the invention comprising the components i) and ii), and its use in crop plants which have been modified by genetic engineering (transgenic) or obtained by mutation selection, and which are resistant to growth regulators such as, for example, 2,4 D, dicamba, or against herbicides which inhibit essential plant enzymes, for example acetolactate synthases (ALS). EPSP synthases, glutamine synthases (GS) or hydroxyphenylpyruvate dioxygenases (HPPD), or respectively to herbicides from the group of the sulfonylureas, glyphosates, glufosinates or benzoylisoxazoles and analogous active compounds, or to any combinations of these active compounds. The herbicidal compositions according to the invention can be used with particular preference in transgenic crop plants which are resistant to a combination of glyphosates and glufosinates, glyphosates and sulfonylureas or imidazolinones. Very particularly preferably, the herbicidal compositions according to the invention can be used in transgenic crop plants such as, for example, corn or soybean with the tradename or the name Optimum™ GAT™ (glyphosate ALS tolerant).

The invention also provides the use of the herbicidal compositions according to the invention comprising the components i) and ii) for controlling harmful plants, preferably in crop plants, preferably in the crop plants mentioned above.

The herbicidal compositions according to the invention can also be used non-selectively for controlling unwanted vegetation, for example in plantation crops, at the wayside, on squares, industrial sites or railway installations; or selectively for controlling unwanted vegetation in crops for energy generation (biogas, bioethanol).

The herbicidal compositions according to the invention can be present both as mixed formulations of components i) and ii) and, if appropriate, with further agrochemical active compounds, additives and/or customary formulation auxiliaries which are then applied in a customary manner diluted with water, or can be prepared as so-called tank mixes by joint dilution of the separately formulated or partially separately formulated components with water. In certain cases, the mixed formulations can be applied diluted with other liquids or solids, or else in undiluted form.

The mixtures/compositions according to the invention can be formulated in various ways, according to the biological and/or physicochemical parameters required. Examples of general formulation options are: wettable powders (WP), water-soluble concentrates, emulsifiable concentrates (EC), aqueous solutions (SL), emulsions (EW), such as oil-in-water and water-in-oil emulsions, sprayable solutions or emulsions, suspension concentrates (SC), dispersions, oil dispersions (OD), suspoemulsions (SE), dusts (DP), seed-dressing products, granules for soil application or spreading (GR) or water-dispersible granules (WG), ultra-low volume formulations, microcapsule dispersions or wax dispersions.

The individual types of formulation are known in principle and are described, for example, in: “Manual on Development and Use of FAO and WHO Specifications for Pesticides”, FAO and WHO, Rome. Italy, 2002; Winnacker-Küchler, “Chemische Technologie” [Chemical Engineering]. Volume 7, C. Hanser Verlag Munich, 4th Ed. 1986; van Valkenburg, “Pesticide Formulations”, Marcel Dekker N.Y. 1973; K. Martens, “Spray Drying Handbook”, 3rd Ed. 1979. G. Goodwin Ltd. London.

The formulation auxiliaries required, such as inert materials, surfactants, solvents and further additives, are likewise known and are described, for example, in: Watkins, “Handbook of Insecticide Dust Diluents and Carriers”, 2nd Ed., Darland Books, Caldwell N.J.; H. v. Olphen, “Introduction to Clay Colloid Chemistry”; 2nd Ed., J. Wiley & Sons. N.Y.; Marsden. “Solvents Guide”, 2nd Ed., Interscience, N.Y. 1950; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte [Interface-active ethylene oxide adducts]”. Wiss. Verlagsgesellschaft, Stuttgart 1976, Winnacker Kuchler, “Chemische Technologie [Chemical Engineering]”, Volume 7, C. Hanser Verlag Munich, 4th Ed. 1986.

Based on these formulations, it is also possible to prepare combinations with other agrochemical active compounds such as fungicides, insecticides and also safeners, fertilizers and/or growth regulators, for example in the form of a ready mix or as tank mix.

Wettable powders (sprayable powders) are products which are uniformly dispersible in water and which, besides the active compounds and in addition to one or more diluents or inert substances, also comprise ionic and/or nonionic surfactants (wetting agents, dispersants), for example polyoxyethylated alkylphenols, polyethoxylated fatty alcohols or fatty amines, propylene oxide/ethylene oxide copolymers, alkanesulfonates or alkylbenzenesulfonates or alkylnaphthalenesulfonates, sodium lignosulfonate, sodium 2,2′-dinaphthylmethane-6,6′-disulfonate, sodium dibutylnaphthalenesulfonate or else sodium oleoylmethyltaurate.

Emulsifiable concentrates are prepared by dissolving the active compounds in an organic solvent or solvent mixture, for example butanol, cyclohexanone, dimethylformamide, acetophenone, xylene or else higher-boiling aromatics or hydrocarbons with addition of one or more ionic and/or nonionic surfactants (emulsifiers). Examples of emulsifiers which may be used are: calcium alkylarylsulfonates such as calcium dodecylbenzenesulfonate, or nonionic emulsifiers such as fatty acid polyglycol esters, alkylaryl polyglycol ethers, fatty alcohol polyglycol ethers, propylene oxide-ethylene oxide copolymers, alkyl polyethers, sorbitan fatty acid esters, polyoxyethylene sorbitan fatty acid esters or polyoxyethylene sorbitol esters.

Dusting products are obtained by grinding the active compound with finely distributed solids, for example talc, natural clays, such as kaolin, bentonite and pyrophyllite, or diatomaceous earth.

Suspension concentrates are water-based suspensions of active compounds. They may be prepared, for example, by wet grinding by means of commercially available bead mills and optional addition of further surfactants as have, for example, already been listed above for the other formulation types. In addition to the suspended active compound or active compounds, other active compounds may also be present in the formulation in dissolved form.

Oil dispersions are oil-based suspensions of active compounds, where oil is to be understood as meaning any organic liquid, for example vegetable oils, aromatic or aliphatic solvents, or fatty acid alkyl esters. They can be prepared, for example, by wet grinding by means of commercially available bead mills and, if appropriate, addition of further surfactants (wetting agents, dispersants) as have already been mentioned, for example, above in the case of the other formulation types. In addition to the suspended active compound or active compounds, other active compounds may also be present in the formulation in dissolved form.

Emulsions, for example oil-in-water emulsions (EW), can be prepared, for example, by means of stirrers, colloid mills and/or static mixers from mixtures of water and water-immiscible organic solvents and, if appropriate, further surfactants as have already been mentioned, for example, above in the case of the other formulation types. Here, the active compounds are present in dissolved form.

Granules can be prepared either by spraying the active compound onto adsorptive, granulated inert material or by applying active compound concentrates to the surface of carriers such as sand, kaolinites, chalk or granulated inert material with the aid of adhesives, for example polyvinyl alcohol, sodium polyacrylate or else mineral oils. Suitable active compounds can also be granulated in the manner customary for the production of fertilizer granules—if desired as a mixture with fertilizers. Water-dispersible granules are produced generally by the customary processes such as spray-drying, fluidized-bed granulation, pan granulation, mixing with high-speed mixers and extrusion without solid inert material. For the production of pan, fluidized-bed, extruder and spray granules, see e.g. processes in “Spray-Drying Handbook” 3rd Ed. 1979, G. Goodwin Ltd., London; J. E. Browning. “Agglomeration”, Chemical and Engineering 1967, pages 147 ff; “Perry's Chemical Engineer's Handbook”, 5th Ed., McGraw Hill, New York 1973, p. 8-57.

For further details regarding the formulation of crop protection compositions, see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications. Oxford, 1968, pages 101-103.

The agrochemical formulations generally comprise from 0.1 to 99% by weight, in particular from 2 to 95% by weight, of active compounds of the herbicide components, the following concentrations being customary, depending on the type of formulation: In wettable powders, the active compound concentration is, for example, about 10 to 95% by weight, the remainder to 100% by weight consisting of customary formulation constituents. In the case of emulsifiable concentrates, the active compound concentration can be, for example, from 5 to 80% by weight. In most cases, formulations in the form of dusts comprise from 5 to 20% by weight of active compound, sprayable solutions comprise about 0.2 to 25% by weight of active compound. In the case of granules such as dispersible granules, the active compound content depends partially on whether the active compound is present in liquid or solid form and on which granulation auxiliaries and fillers are used. In water-dispersible granules, the content is generally between 10 and 90% by weight.

In addition, the active compound formulations mentioned optionally comprise the respective customary adhesives, wetting agents, dispersants, emulsifiers, preservatives, antifreeze agents and solvents, fillers, colourants and carriers, antifoams, evaporation inhibitors and pH- or viscosity-modifying agents.

The herbicidal action of the mixtures/compositions according to the invention can be improved, for example, by surfactants, for example by wetting agents from the group of the fatty alcohol polyglycol ethers. The fatty alcohol polyglycol ethers preferably comprise 10-18 carbon atoms in the fatty alcohol radical and 2-20 ethylene oxide units in the poly glycol ether moiety. The fatty alcohol poly glycol ethers may be present in nonionic form, or ionic form, for example in the form of fatty alcohol polyglycol ether sulfates or phosphates, which are used, for example, as alkali metal salts (for example sodium salts and potassium salts) or ammonium salts, or even as alkaline earth metal salts, such as magnesium salts, such as C₁₂/C₁₄-fatty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-C₁₄)-fatty alcohol polyglycol ethers (for example isotridecyl alcohol polyglycol ethers) which comprise 2-20, preferably 3-15, ethylene oxide units, for example from the Genapol® X series, such as Genapol® X-030, Genapol® X-060, Genapol® X-080 or Genapol® X-150 (all from Clariant GmbH).

The present invention further comprises the combination of the mixtures/compositions according to the invention with the wetting agents mentioned above from the group of the fatty alcohol polyglycol ethers which preferably contain 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to sodium C₂/C₁₄-fatty alcohol diglycol ether sulfate (Genapol® LRO, Clariant GmbH) and isotridecyl alcohol polyglycol ethers having 3-15 ethylene oxide units, for example from the Genapol® X series, such as Genapol® X-030, Genapol® X-060, Genapol® X-080 and Genapol® X-150 (all from Clariant GmbH). It is also known that fatty alcohol polyglycol ethers, such as nonionic or ionic fatty alcohol polyglycol ethers (for example fatty alcohol poly glycol ether sulfates) are also suitable as penetrants and activity enhancers for a number of other herbicides, including herbicides from the group of the imidazolinones (see, for example, EP-A-0502014).

The herbicidal action of the mixtures/compositions according to the invention can also be enhanced by using vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₂-C₂₀-, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular C₁₈-fatty acids such as stearic acid, oleic acid, linoleic acid or linolenic acid.

Examples of C₁₀-C₂₂-fatty acid esters are esters which are obtained by reacting glycerol or glycol with the C₁₀-C₂₂-fatty acids present, for example, in oils of oleaginous plant species, or C₁₀-C₂₂-fatty acid C₁-C₂₀-alkyl esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Römpp Chemie Lexikon, 9th edition, Volume 2, page 1343, Thieme Verlag Stuttgart.

Preferred C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and in particular Cis-fatty acids such as stearic acid, oleic acid, linoleic acid or linolenic acid.

In the herbicidal mixtures/compositions according to the invention, the vegetable oils can be present, for example, in the form of commercially available oil-containing formulation additives, in particular those based on rapeseed oil, such as Hasten® (Victorian Chemical Company. Australia, hereinbelow referred to as Hasten, main ingredient: rapeseed oil ethyl ester), Actirob® B (Novance France, hereinbelow referred to as ActirobB, main ingredient: rapeseed oil methyl ester), Rako-Binol® (Bayer AG. Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention embraces combinations of the components i) and ii) with the vegetable oils mentioned above, such as rapeseed oil, preferably in the form of commercially available oil-containing formulation additives, in particular those based on rapeseed oil, such as Hasten®, Actirob® B, Rako-Binol®, Renol® or Stefes Mero®.

For application, the formulations in commercial form are, if appropriate, diluted in a customary manner, for example in the case of wettable powders, emulsifiable concentrates, dispersions and water-dispersible granules with water. Dust-type preparations, granules for soil application or granules for scattering and sprayable formulations are not normally diluted further with other inert substances prior to application.

The active compounds can be applied to the plants, plant parts, plant seeds or area under cultivation (soil), preferably on the green plants and plant parts, and optionally additionally to the soil.

One possible use is the joint application of the active compounds in the form of tank mixes, where the optimally formulated concentrated formulations of the individual active compounds are, together, mixed in a tank with water, and the spray liquor obtained is applied.

A joint herbicidal formulation of the herbicidal compositions according to the invention comprising the components i) and ii) has the advantage that it can be applied more easily since the quantities of the components are already adjusted to the correct ratio to one another. Moreover, the auxiliaries in the formulation can be optimized to one another.

### A. GENERAL FORMULATION EXAMPLES

a) A dust is obtained by mixing 10 parts by weight of an active compound/active compound mixture and 90 parts by weight of talc as inert substance and comminuting the mixture in a hammer mill.
b) A wettable powder which is readily dispersible in water is obtained by mixing 25 parts by weight of an active compound/active compound mixture, 64 parts by weight of kaolin-containing clay as inert substance, 10 parts by weight of potassium lignosulfonate and 1 part by weight of sodium oleoylmethyltaurate as wetting agent and dispersant, and grinding the mixture in a pinned-disc mill.
c) A suspension concentrate which is readily dispersible in water is obtained by mixing 20 parts by weight of an active compound/active compound mixture with 5 parts by weight of tristyrylphenol polyglycol ether (Soprophor BSU), 1 part by weight of sodium lignosulfonate (Vanisperse CB) and 74 parts by weight of water, and grinding the mixture in a friction ball mill to a fineness of below 5 microns.
d) An oil dispersion which is readily dispersible in water is obtained by mixing 20 parts by weight of an active compound/active compound mixture with 6 parts by weight of alkylphenol polyglycol ether (Triton® X 207), 3 parts by weight of isotridecanol polyglycol ether (8 EO) and 71 parts by weight of paraffinic mineral oil (boiling range for example approx. 255 to 277° C.), and grinding the mixture in a friction ball mill to a fineness of below 5 microns.
e) An emulsifiable concentrate is obtained from 15 parts by weight of an active compound/active compound mixture, 75 parts by weight of cyclohexanone as solvent and 10 parts by weight of oxyethylated nonylphenol as emulsifier.
f) Water-dispersible granules are obtained by mixing
   75 parts by weight of an active compound/active compound mixture,
   10 parts by weight of calcium lignosulfonate,
   5 parts by weight of sodium lauryl sulfate,
   3 parts by weight of polyvinyl alcohol and
   7 parts by weight of kaolin,
   grinding the mixture in a pinned-disk mill, and granulating the powder in a fluidized bed by spray application of water as a granulating liquid.
g) Water-dispersible granules are also obtained by homogenizing and precomminuting, in a colloid mill,
   25 parts by weight of an active compound/active compound mixture.
   5 parts by weight of sodium 2,2′-dinaphthylmethane-6,6′-disulfonate
   2 parts by weight of sodium oleoylmethyltaurate,
   1 part by weight of polyvinyl alcohol.
   17 parts by weight of calcium carbonate and
   50 parts by weight of water, then grinding the mixture in a bead mill and atomizing and drying the resulting suspension in a spray tower by means of a one-phase nozzle.

### B. BIOLOGICAL EXAMPLES

a) Description of the Methods

Greenhouse Trials

In the standard implementation of the test, seeds of various broad-leaved weed and weed grass biotypes (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated on a laboratory track sprayer with spray liquors comprising the mixtures/compositions according to the invention, mixtures of the prior art or the components applied individually. Application of the active compounds or active compound combinations formulated as WG, WP, EC or otherwise was carried out at the appropriate growth stages of the plants. The amount of water used for spray application was 100-600 l/ha. After the treatment, the plants were returned to the greenhouses.

About 3 weeks after the application, the soil action or/and foliar action was assessed visually according to a scale of 0-100% in comparison to an untreated comparative group: 0%=no noticeable effect compared to the untreated comparative group; 100%=full effect compared to the untreated comparative group.

(Notes: the term “seeds” also includes vegetative propagation forms such as, for example, rhizome pieces: abbreviations used: h light=hours of illumination, g of AS/ha=grams of active substance per hectare, l/ha=litres per hectare, S=sensitive, R=resistant)
1. Pre-emergence action against weeds: Seeds of various broad-leaved weed and weed grass biotypes (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated at BBCH stage 00-10 of the seeds/plants on a laboratory track sprayer with spray liquors comprising the mixtures/compositions according to the invention, mixtures or the components applied individually as WG, WP, EC or other formulations. The amount of water used for spray application was 100-600 l/ha. After the treatment, the plants were returned to the greenhouses and fertilized and watered as required.
2. Post-emergence action against weeds: Seeds of various broad-leaved weed and weed grass biotypes (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated at various BBCH stages between 11-25 of the seeds/plants, i.e. generally between two to three weeks after the start of the cultivation, on a laboratory track sprayer with spray liquors comprising the mixtures/compositions according to the invention, mixtures or the components applied individually as WG, WP. EC or other formulations. The amount of water used for spray application was 100-600/a. After the treatment, the plants were returned to the greenhouses and fertilized and watered as required.
3. Pre-emergence action against weeds with and without active compound incorporation: Seeds of various broad-leaved weed and weed grass biotypes (origins) were sown in an 8-13 cm diameter pot filled with natural soil of a standard field soil (loamy silt). Depending on the trial conditions, the soil of the standard field soil is sterile or not sterile. For comparison, either the pots with the seeds were treated at BBCH stage 00-10 of the seeds/plants, i. e. generally two to three weeks after the start of the cultivation, on a laboratory track sprayer with spray liquors comprising the mixtures/compositions according to the invention, mixtures or the components applied individually as WG. WP. EC or other formulations, or an equivalent amount of the mixtures/compositions according to the invention, mixtures or the components applied individually as WG, WP, EC or other formulations was incorporated into the 1 cm covering layer. The amount of water used for spray application was 100-600 l/ha. After the treatment, the plants were returned to the greenhouses and fertilized and watered as required. The pots were cultivated in a greenhouse (12-16 h light, temperature day 20-22° C. night 15-18° C.).
4. Selective pre-emergence action: Seeds of various crop species (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated at BBCH stage 00-10 of the seeds/plants on a laboratory track sprayer with spray liquors comprising the mixtures/compositions according to the invention, mixtures or the components applied individually as WG. WP, EC or other formulations. The amount of water used for spray application was 100-600l/ha. After the treatment, the plants were returned to the greenhouses and fertilized and watered as required.
5. Selective post-emergence action: Seeds of various crop species (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C. night 15-18° C.) until the time of application. The pots were treated at various BBCH stages 11-32 of the seeds/plants, i.e. generally between two to four weeks after the start of the cultivation, on a laboratory track sprayer with spray liquors comprising the mixtures/compositions according to the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (12-16 h light, temperature day 20-22° C., night 15-18° C.).
6. Pre-emergence action against weeds: Seeds of various broad-leaved weed and weed grass biotypes (origins) were sown in an 8-13 cm diameter pot filled with natural soil of a standard field soil (loamy silt). Depending on the trial conditions, the soil of the standard field soil is sterile or not sterile. The pots with the seeds were treated prior to sowing on a laboratory track sprayer with spray liquors comprising the mixtures/compositions according to the invention, mixtures or the components applied individually as WG, WP, EC or other formulations. The amount of water used for spray application was 100-600 l/ha. After sowing, the pots were placed in the greenhouses and fertilized and watered as required. The pots were cultivated in a greenhouse (12-16 h light, temperature day 20-22° C., night 15-18° C.).
7. Pre-emergence and post-emergence action against weeds under various cultivation conditions: Seeds of various broad-leaved weed and weed grass biotypes (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated at various BBCH stages 00-25 of the seeds/plants on a laboratory track sprayer with spray liquors comprising the mixtures compositions according to the invention, mixtures or the components applied individually as WG. WP, EC or other formulations. The amount of water used for spray application was 100-600 l/ha. After the treatment, the plants were returned to the greenhouses and fertilized and watered as required. The pots were cultivated in a greenhouse (12-16 h light, temperature day 20-22° C., night 15-18° C.). Irrigation was varied according to the issue. Here, the individual comparative groups were provided with gradually differing amounts of water in a range from above the PWP (permanent wilting point) up to the level of maximum field capacity.
8. Pre-emergence and post-emergence action against weeds under various irrigation conditions: Seeds of various broad-leaved weed and weed grass biotypes (origins) were sown in an 8-13 cm diameter pot filled with natural soil of a standard field soil (loamy silt) and covered with a covering soil layer of about 1 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated at various BBCH stages 00-25 of the seeds/plants on a laboratory track sprayer with spray liquors comprising the mixtures/compositions according to the invention, mixtures or the components applied individually as WG. WP, EC or other formulations. The amount of water used for spray application was 100-600 l/ha. After the treatment, the plants were returned to the greenhouses and fertilized and watered as required. The pots were cultivated in a greenhouse (12-16 h light, temperature day 20-22° C., night 15-18° C.). The individual comparative groups were subjected to different irrigation techniques. Irrigation was either from below or gradually from above (simulated rain).
9. Pre-emergence and post-emergence action against weeds under various soil conditions: seeds of various broad-leaved weed and weed grass biotypes (origins) were sown in an 8-13 cm diameter pot filled with natural soil and covered with a covering soil layer of about 1 cm. To compare the herbicidal action, the plants were cultivated in various cultivation soils from sandy soil to heavy clay soil and various contents of organic substance. Depending on the trial conditions, the cultivation soils are sterile or not sterile. The pots were then cultivated in a greenhouse (12-16 h light, temperature day 20-22° C. night 15-18° C.) until the time of application. The pots were treated at various BBCH stages 00-25 of the seeds/plants on a laboratory track sprayer with spray liquors comprising the mixtures/compositions according to the invention, mixtures or the components applied individually as WG, WP. EC or other formulations. The amount of water used for spray application was 100-600 l/ha. After the treatment, the plants were returned to the greenhouses and fertilized and watered as required. The pots were cultivated in a greenhouse (12-16 h light, temperature day 20-22° C. night 15-18° C.).
10. Pre-emergence and post-emergence action against weeds for the control of resistant weed grass/broad-leaved weed species: seeds of various broad-leaved weed and weed grass biotypes (origins) having various resistance mechanisms against different modes of action were sown in an 8 cm diameter pot filled with natural soil of a standard field soil (loamy silt, LSI; pH 7.4; % C org 2.2) and covered with a covering soil layer of about 1 cm. Depending on the trial conditions, the soil of the standard field soil is sterile or not sterile. The pots were then cultivated in a greenhouse (12-16 h light, temperature day about 23° C., night about 15° C.) until the time of application. The pots were treated at various BBCH stages 00-25 of the seeds/plants on a laboratory track sprayer with spray liquors comprising the mixtures/compositions according to the invention, mixtures or the components applied individually as WG, WP, EC or other formulations. The amount of water used for spray application was 300 l/ha. After the treatment, the plants were returned to the greenhouses and fertilized and watered as required. The pots were cultivated in a greenhouse (12-16 h light, temperature day about 23° C. night about 15° C.).
11. Pre-emergence and post-emergence action against weeds and crop selectivity under various sowing conditions: seeds of various broad-leaved weed and weed grass biotypes (origins) and crop species (origins) were sown in an 8-13 cm diameter pot filled with natural soil and covered with a covering soil layer of about 0-5 cm. Depending on the trial conditions, the soil of the standard field soil is sterile or not sterile. The pots were then cultivated in a greenhouse (12-16 h light, temperature day 20-22° C., night 15-18° C.) until the time of application. The pots were treated at various BBCH stages 00-25 of the seeds/plants on a laboratory track sprayer with spray liquors comprising the mixtures/compositions according to the invention, mixtures or the components applied individually as WG, WP. EC or other formulations. The amount of water used for spray application was 100-600 l/ha. After the treatment, the plants were returned to the greenhouses and fertilized and watered as required. The pots were cultivated in a greenhouse (12-16 h light, temperature day 20-22° C. night 15-18° C.).
12. Pre-emergence and post-emergence action against weeds at different pH values of the soil: seeds of various broad-leaved weed and weed grass biotypes (origins) were sown in an 8-13 cm diameter pot filled with natural soil and covered with a covering soil layer of about 1 cm. For comparison of the herbicidal activity, the plants were cultivated in cultivation soils of a standard field soil (loamy silt) with different pH values of pH 7.4 and pH 8.4. Accordingly, the soil was mixed with lime to achieve the higher pH value. Depending on the trial conditions, the soil of the standard field soil is sterile or not sterile. The pots were then cultivated in a greenhouse (12-16 h light, temperature day 20-22° C., night 15-18° C.) until the time of application. The pots were treated at various BBCH stages 00-10 of the seeds/plants on a laboratory track sprayer with spray liquors comprising the mixtures/compositions according to the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (12-16 h light, temperature day 20-22° C., night 15-18° C.).

Outdoor Trials

In outdoor trials under natural conditions with the field being prepared in a manner customary in practice and with natural or artificial infestation with harmful plants, the compositions according to the invention, mixtures of the prior art or the individual components were applied before or after sowing of the crop plants or before or after emergence of the harmful plants, and visual scoring was carried out over a period of 4 weeks to 8 months after the treatment by comparison with untreated sections (plots). Here the damage to the crop plants and the action against harmful plants were recorded in percent, as were the other effects of the respective trial question.

b) Results

The results were obtained using the following method:

Pre-emergence action against weeds: Seeds of various broad-leaved weed and weed grass biotypes (origins) were sown in an 8 cm diameter pot filled with natural soil of a standard field soil (loamy silt; steamed) and covered with a covering soil layer of about 1 cm. The pots were then cultivated in a greenhouse (12-16 h light, temperature day 20-22° C. night 15-18° C.) until the time of application. The pots were treated at BBCH stage 00-06 of the seeds on a laboratory track sprayer with spray liquors comprising the mixtures/compositions according to the invention, mixtures or the components applied individually as WG, WP, EC or other formulations. The amount of water used for spray application was 300l/ha. After the treatment, the plants were returned to the greenhouses and fertilized and watered as required.

The following abbreviations were used:

BBCH=the BBCH code provides information about the morphological development stage of a plant. Officially, the abbreviation denotes the Biologische Bundesanstalt, Bundessortenamt und Chemische Industrie [Federal Biological Institute for Agriculture and Forestry, Federal Office for Crop Plant Varieties and Chemical Industry]. The range of BBCH 00-10 denotes the germination stages of the seeds until surface penetration. The range of BBCH 11-25 denotes the leaf development stages until stocking (corresponding to the number of tillers or side-shoots).

PE=pre-emergence application on the soil; BBCH of the seeds/plants 00-10.

PO=post-emergence application on the green parts of the plants; BBCH of the plants 11-25.

HRAC=Herbicide Resistance Action Committee which classifies the approved active compounds according to their mode of action (MoA).

HRAC group A=acetyl coenzyme A carboxylase inhibitors (MoA: ACCase).

HRAC group B=acetolactate synthase inhibitors (MoA: ALS).

AS=active substance (based on 100% of active ingredient; syn, a.i.).

Dosage g of AS/ha=application rate in grams of active substance per hectare.

In the trials, the following biotypes of broad-leaved weeds and weed grasses were used:

ALOMY—sensitive (Alopecurus myosuroides) sensitive to customary herbicidally active compounds.

ALOMY—resistant (Alopecurus myosuroides) resistant to herbicidally active compounds of the HRAC groups A and B; population mixture of field origin having increased metabolic resistance (IMR) and some target site resistance (TSR).

LOLRI—sensitive (Lolium rigidum) sensitive to customary herbicidally active compounds.

LOLRI—resistant (Lolium rigidum) resistant to herbicidally active compounds of the HRAC groups A and B; population mixture of field origin having increased metabolic resistance (IMR) and some target site resistance (TSR).

AVEFA (Avenafatua)—Wild oat

BROST (Bromus sterilis)—Bromegrass, barren

SORHA (Sorghum halepense)—Johnsongrass

BRSNW (Brassica napus)—Rape, winter

CENCY (Centaurea cyanus)—Cornflower

EMEAU (Emex australis)—Cathead

GALAP (Gallium aparine)—Cleaver

PAPRH (Papaver rhoeas)—Poppy, common

RAPRA (Raphanus raphanistrum)—Charlock, jointed

VERHE (Veronica hederaefolia)—Speedwell, iveleaf

HORVS (Hordeum vulgare)—Barley, spring

TRZAS (Triticum aestivum)—Wheat, spring

The activities of the herbicidal compositions according to the invention meet the stated requirements and therefore solve the object of improving the application profile of the herbicidally active compound 2-[(2,4-dichlorophenyl)methyl]-4,4-dimethyl-3-isoxazolidinone (inter alia provision of more flexible solutions with regard to the application rates required for unchanged to enhanced activity).

Insofar as herbicidal effects of the compositions according to the invention compared to mixtures of the prior art or compared to components applied individually against economically important mono- and dicotyledonous harmful plants were the centre of attention, the synergistic herbicidal activities were calculated using Colby's formula (cf. S. R. Colby; Weeds 15 (1967), 20-22):

TABLE 1

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | PAPRH |
| 2-[(2,4-Di- | 500 | 95 | 95 | 95 | 94 | 80 | 75 | 95 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 80 | 70 | 90 | 85 | 0 | 50 | 0 |
| 2-[(2,4-Di- | 500 + 50 | 100 | 99 | 99 | 100 | 95 | 95 | 99 |
| chlorophenyl)- | | | | | | | | |
| methyl]-4,4- | | | | | | | | |
| dimethyl-3- | | | | | | | | |
| isoxazolidinone + | | | | | | | | |
| Cinmethylin | | | | | | | | |
| Expected | — | 99 | 99 | 100 | 99 | 80 | 88 | 95 |
| according to | | | | | | | | |
| COLBY | | | | | | | | |
| Synergism | — | 1 | 1 | −1 | 1 | 15 | 8 | 4 |

| | Dose | | | | | | |
|---|---|---|---|---|---|---|---|
| | in g | | | | | | |
| | AS/ha | VERHE | EMEAU | RAPRA | BRSNW | TRZAS | HORVS |
| 2-[(2,4-Di- | 500 | 95 | 70 | 90 | 20 | 70 | 60 |
| chlorophenyl)- | | | | | | | |
| methyl]-4,4- | | | | | | | |
| dimethyl-3- | | | | | | | |
| isoxazolidinone | | | | | | | |
| Cinmethylin | 50 | 0 | 0 | 0 | 0 | 30 | 30 |
| 2-[(2,4-Di- | 500 + 50 | 98 | 95 | 95 | 20 | 80 | 95 |
| chlorophenyl)- | | | | | | | |
| methyl]-4,4- | | | | | | | |
| dimethyl-3- | | | | | | | |
| isoxazolidinone + | | | | | | | |
| Cinmethylin | | | | | | | |
| Expected | — | 95 | 70 | 90 | 20 | 72 | 20 |
| according to | | | | | | | |
| COLBY | | | | | | | |
| Synergism | — | 3 | 25 | 5 | 0 | 1 | 23 |

TABLE 2

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | PAPRH |
| 2-[(2,4-Di- | 400 | 95 | 95 | 95 | 94 | 75 | 70 | 95 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 10 | 0 | 0 | 0 | 0 | 0 | 0 | 0 |
| 2-[(2,4-Di- | 400 + 10 | 100 | 98 | 100 | 100 | 85 | 78 | 99 |
| chlorophenyl)- | | | | | | | | |
| methyl]-4,4- | | | | | | | | |
| dimethyl-3- | | | | | | | | |
| isoxazolidinone + | | | | | | | | |
| Cinmethylin | | | | | | | | |
| Expected | — | 95 | 95 | 95 | 94 | 75 | 70 | 95 |
| according to | | | | | | | | |
| COLBY | | | | | | | | |
| Synergism | — | 5 | 3 | 5 | 6 | 10 | 8 | 4 |

| | Dose | | | | | | |
|---|---|---|---|---|---|---|---|
| | in g | | | | | | |
| | AS/ha | VERHE | EMEAU | RAPRA | BRSNW | TRZAS | HORVS |
| 2-[(2,4-Di- | 400 | 95 | 70 | 80 | 20 | 60 | 60 |
| chlorophenyl)- | | | | | | | |
| methyl]-4,4- | | | | | | | |
| dimethyl-3- | | | | | | | |
| isoxazolidinone | | | | | | | |
| Cinmethylin | 10 | 0 | 0 | 0 | 0 | 0 | 0 |
| 2-[(2,4-Di- | 400 + 10 | 97 | 70 | 80 | 30 | 80 | 95 |
| chlorophenyl)- | | | | | | | |
| methyl]-4,4- | | | | | | | |
| dimethyl-3- | | | | | | | |
| isoxazolidinone | | | | | | | |
| + | | | | | | | |
| Cinmethylin | | | | | | | |
| Expected | — | 95 | 70 | 80 | 20 | 60 | 60 |
| according to | | | | | | | |
| COLBY | | | | | | | |
| Synergism | — | 2 | 0 | 0 | 10 | 20 | 35 |

TABLE 3

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | PAPRH |
| 2-[(2,4-Di- | 400 | 95 | 95 | 95 | 94 | 75 | 70 | 95 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 25 | 80 | 60 | 70 | 70 | 0 | 20 | 0 |
| 2-[(2,4-Di- | 400 + 25 | 100 | 98 | 98 | 99 | 93 | 95 | 98 |
| chlorophenyl)- | | | | | | | | |
| methyl]-4,4- | | | | | | | | |
| dimethyl-3- | | | | | | | | |
| isoxazolidinone + | | | | | | | | |
| Cinmethylin | | | | | | | | |
| Expected | — | 99 | 98 | 99 | 98 | 75 | 76 | 95 |
| according to | | | | | | | | |
| COLBY | | | | | | | | |
| Synergism | — | 1 | 0 | −1 | 1 | 18 | 19 | 3 |
| | Dose | | | | | | | |
| | in g | | | | | | | |
| | AS/ha | VERHE | EMEAU | RAPRA | BRSNW | | TRZAS | HORVS |
| 2-[(2,4-Di- | 400 | 95 | 70 | 80 | 20 | | 60 | 60 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 25 | 0 | 0 | 0 | 0 | | 0 | 0 |
| 2-[(2,4-Di- | 400 + 25 | 98 | 75 | 80 | 20 | | 80 | 75 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 95 | 70 | 80 | 20 | | 60 | 60 |
| according to | | | | | | | | |
| COLBY | | | | | | | | |
| Synergism | — | 3 | 5 | 0 | 0 | | 20 | 15 |

TABLE 4

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | PAPRH |
| 2-[(2,4-Di- | 250 | 93 | 93 | 95 | 80 | 75 | 65 | 95 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 25 | 80 | 60 | 70 | 70 | 0 | 20 | 0 |
| 2-[(2,4-Di- | 250 + 25 | 100 | 95 | 98 | 93 | 85 | 80 | 98 |
| chlorophenyl)- | | | | | | | | |
| methyl]-4,4- | | | | | | | | |
| dimethyl-3- | | | | | | | | |
| isoxazolidinone + | | | | | | | | |
| Cinmethylin | | | | | | | | |
| Expected | — | 99 | 97 | 99 | 94 | 75 | 72 | 95 |
| according to | | | | | | | | |
| COLBY | | | | | | | | |
| Synergism | — | 1 | −2 | −1 | −1 | 10 | 8 | 3 |
| | Dose | | | | | | | |
| | in g | | | | | | | |
| | AS/ha | VERHE | EMEAU | RAPRA | BRSNW | | TRZAS | HORVS |
| 2-[(2,4-Di- | 250 | 95 | 60 | 60 | 20 | | 50 | 50 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 25 | 0 | 0 | 0 | 0 | | 0 | 0 |
| 2-[(2,4-Di- | 250 + 25 | 97 | 65 | 80 | 10 | | 40 | 70 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 95 | 60 | 60 | 20 | | 50 | 50 |
| according to | | | | | | | | |
| COLBY | | | | | | | | |
| Synergism | — | 2 | 5 | 20 | −10 | | −10 | 20 |

TABLE 5

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 50 | 20 | 10 | 70 | 60 | 15 | 0 | 30 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 500 | 100 | 100 | 100 | 100 | 70 | 100 | 100 |
| 2-[(2,4-Di- | 50 + 500 | 100 | 100 | 100 | 100 | 85 | 100 | 95 |
| chlorophenyl)- | | | | | | | | |
| methyl]-4,4- | | | | | | | | |
| dimethyl-3- | | | | | | | | |
| isoxazolidinone + | | | | | | | | |
| Cinmethylin | | | | | | | | |
| Expected | — | 100 | 100 | 100 | 100 | 75 | 100 | 100 |
| according to | | | | | | | | |
| COLBY | | | | | | | | |
| Synergism | — | 0 | 0 | 0 | 0 | 11 | 0 | −5 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 50 | 10 | 70 | 10 | 20 | 0 | 0 | 5 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 500 | 80 | 0 | 0 | 40 | 10 | 90 | 70 |
| 2-[(2,4-Di- | 50 + 500 | 70 | 97 | 40 | 60 | 50 | 80 | 90 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 82 | 70 | 10 | 52 | 10 | 90 | 72 |
| according to | | | | | | | | |
| COLBY | | | | | | | | |
| Synergism | — | −12 | 27 | 30 | 8 | 40 | −10 | 19 |

TABLE 6

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 25 | 0 | 0 | 30 | 5 | 5 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 250 | 100 | 90 | 100 | 100 | 50 | 100 | 80 |
| 2-[(2,4-Di- | 25 + 250 | 100 | 100 | 100 | 100 | 75 | 100 | 90 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 100 | 90 | 100 | 100 | 53 | 100 | 80 |
| according to | | | | | | | | |
| COLBY | | | | | | | | |
| Synergism | — | 0 | 10 | 0 | 0 | 23 | 0 | 10 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 25 | 0 | 40 | 0 | 5 | 0 | 0 | 2 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 250 | 30 | 0 | 0 | 30 | 0 | 75 | 65 |
| 2-[(2,4-Di- | 25 + 250 | 90 | 95 | 40 | 40 | 20 | 75 | 75 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 30 | 40 | 0 | 34 | 0 | 75 | 66 |
| according to | | | | | | | | |
| COLBY | | | | | | | | |
| Synergism | — | 60 | 55 | 40 | 7 | 20 | 0 | 9 |

TABLE 7

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 10 | 0 | 0 | 0 | 0 | 0 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 500 | 100 | 100 | 100 | 100 | 70 | 100 | 100 |
| 2-[(2,4-Di- | 10 + 500 | 100 | 100 | 100 | 100 | 80 | 100 | 100 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 100 | 100 | 100 | 100 | 70 | 100 | 100 |
| according to | | | | | | | | |
| COLBY | | | | | | | | |
| Synergism | — | 0 | 0 | 0 | 0 | 10 | 0 | 0 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 10 | 0 | 15 | 0 | 0 | 0 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 500 | 80 | 0 | 0 | 40 | 10 | 90 | 70 |
| 2-[(2,4-Di- | 10 + 500 | 90 | 90 | 0 | 40 | 15 | 90 | 95 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 80 | 15 | 0 | 40 | 10 | 90 | 70 |
| according to | | | | | | | | |
| COLBY | | | | | | | | |
| Synergism | — | 10 | 75 | 0 | 0 | 5 | 0 | 25 |

TABLE 8

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 10 | 0 | 0 | 0 | 0 | 0 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 250 | 100 | 90 | 100 | 100 | 50 | 100 | 80 |
| 2-[(2,4-Di- | 10 + 250 | 100 | 100 | 100 | 100 | 65 | 100 | 90 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 100 | 90 | 100 | 100 | 50 | 100 | 80 |
| according to | | | | | | | | |
| COLBY | | | | | | | | |
| Synergism | — | 0 | 10 | 0 | 0 | 15 | 0 | 10 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 10 | 0 | 15 | 0 | 0 | 0 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 250 | 30 | 0 | 0 | 30 | 0 | 75 | 65 |
| 2-[(2,4-Di- | 10 + 250 | 90 | 50 | 0 | 30 | 15 | 65 | 95 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 30 | 15 | 0 | 30 | 0 | 75 | 65 |
| according to | | | | | | | | |
| COLBY | | | | | | | | |
| Synergism | — | 60 | 35 | 0 | 0 | 15 | −10 | 30 |

TABLE 9

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 10 | 0 | 0 | 0 | 0 | 0 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 90 | 70 | 100 | 100 | 25 | 100 | 70 |
| 2-[(2,4-Di- | 10 + 100 | 100 | 100 | 100 | 100 | 25 | 100 | 85 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 90 | 70 | 100 | 100 | 75 | 100 | 70 |
| according to | | | | | | | | |
| COLBY | | | | | | | | |
| Synergism | — | 10 | 30 | 0 | 0 | 0 | 0 | 15 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 10 | 0 | 15 | 0 | 0 | 0 | 0 | 0 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 0 | 0 | 0 | 0 | 0 | 40 | 40 |
| 2-[(2,4-Di- | 10 + 100 | 93 | 10 | 0 | 30 | 15 | 40 | 50 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 0 | 15 | 0 | 0 | 0 | 40 | 40 |
| according to | | | | | | | | |
| COLBY | | | | | | | | |
| Synergism | — | 93 | −5 | 0 | 30 | 15 | 0 | 10 |

TABLE 10

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 100 | 60 | 60 | 70 | 70 | 50 | 20 | 40 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 90 | 70 | 100 | 100 | 25 | 100 | 70 |
| 2-[(2,4-Di- | 100 + 100 | 100 | 99 | 100 | 100 | 80 | 95 | 100 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 96 | 88 | 100 | 100 | 63 | 100 | 82 |
| according to | | | | | | | | |
| COLBY | | | | | | | | |
| Synergism | — | 4 | 11 | 0 | 0 | 18 | −5 | 18 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 100 | 70 | 80 | 20 | 40 | 0 | 5 | 15 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 0 | 0 | 0 | 0 | 0 | 40 | 40 |
| 2-[(2,4-Di- | 100 + 10 | 88 | 100 | 60 | 60 | 30 | 20 | 65 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 70 | 80 | 20 | 40 | 0 | 43 | 49 |
| according to | | | | | | | | |
| COLBY | | | | | | | | |
| Synergism | — | 18 | 20 | 40 | 20 | 30 | −23 | 16 |

TABLE 11

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 200 | 95 | 80 | 90 | 80 | 70 | 30 | 60 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 90 | 70 | 100 | 100 | 25 | 100 | 70 |
| 2-[(2,4-Di- | 200 + 100 | 100 | 99 | 100 | 100 | 75 | 96 | 95 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 100 | 94 | 100 | 100 | 78 | 100 | 88 |
| according to | | | | | | | | |
| COLBY | | | | | | | | |
| Synergism | — | 1 | 1 | 5 | 0 | −3 | −4 | 7 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 200 | 88 | 90 | 40 | 50 | 5 | 40 | 40 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 0 | 0 | 0 | 0 | 0 | 40 | 40 |
| 2-[(2,4-Di- | 200 + 100 | 95 | 99 | 80 | 60 | 20 | 50 | 70 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 88 | 90 | 40 | 50 | 5 | 64 | 64 |
| according to | | | | | | | | |
| COLBY | | | | | | | | |
| Synergism | — | 7 | 9 | 40 | 10 | 15 | −14 | 6 |

TABLE 12

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 100 | 60 | 60 | 70 | 70 | 50 | 20 | 40 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 80 | 70 | 90 | 85 | 0 | 50 | 65 |
| 2-[(2,4-Di- | 100 + 50 | 100 | 100 | 97 | 100 | 70 | 93 | 90 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 92 | 88 | 97 | 96 | 50 | 60 | 79 |
| according to | | | | | | | | |
| COLBY | | | | | | | | |
| Synergism | — | 8 | 12 | 0 | 5 | 20 | 33 | 11 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 100 | 70 | 80 | 20 | 40 | 0 | 5 | 15 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 0 | 0 | 0 | 0 | 0 | 30 | 30 |
| 2-[(2,4-Di- | 100 + 50 | 85 | 98 | 60 | 50 | 20 | 30 | 30 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 70 | 80 | 20 | 40 | 0 | 34 | 41 |
| according to | | | | | | | | |
| COLBY | | | | | | | | |
| Synergism | — | 15 | 18 | 40 | 10 | 20 | −4 | −11 |

TABLE 13

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 50 | 20 | 20 | 70 | 30 | 15 | 0 | 30 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 90 | 70 | 100 | 100 | 25 | 100 | 70 |
| 2-[(2,4-Di- | 50 + 100 | 100 | 100 | 100 | 100 | 70 | 90 | 90 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 92 | 76 | 100 | 100 | 36 | 100 | 79 |
| according to | | | | | | | | |
| COLBY | | | | | | | | |
| Synergism | — | 8 | 24 | 0 | 0 | 34 | −10 | 11 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 50 | 10 | 70 | 10 | 20 | 0 | 0 | 5 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 100 | 0 | 0 | 0 | 0 | 0 | 40 | 40 |
| 2-[(2,4-Di- | 50 + 100 | 85 | 100 | 60 | 40 | 20 | 20 | 25 |
| chlorophenyl)- | | | | | | | | |
| methyl]-4,4- | | | | | | | | |
| dimethyl-3- | | | | | | | | |
| isoxazolidinone | | | | | | | | |
| + | | | | | | | | |
| Cinmethylin | | | | | | | | |
| Expected | — | 10 | 70 | 10 | 20 | 0 | 40 | 43 |
| according to | | | | | | | | |
| COLBY | | | | | | | | |
| Synergism | — | 75 | 30 | 50 | 20 | 20 | −20 | −18 |

TABLE 14

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 100 | 60 | 60 | 70 | 75 | 50 | 20 | 40 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 80 | 70 | 90 | 100 | 0 | 50 | 65 |
| Mefenpyr | 300 | 0 | 0 | 0 | 0 | 0 | 0 | 0 |
| 2-[(2,4-Di- | 100 + 50 | 100 | 90 | 98 | 100 | 55 | 90 | 80 |
| chlorophenyl)- | + | | | | | | | |
| methyl]-4,4- | 300 | | | | | | | |
| dimethyl-3- | | | | | | | | |
| isoxazolidinone | | | | | | | | |
| + | | | | | | | | |
| Cinmethylin + | | | | | | | | |
| Mefenpyr | | | | | | | | |
| Expected | — | 92 | 88 | 97 | 100 | 50 | 60 | 79 |
| according to | | | | | | | | |
| COLBY | | | | | | | | |
| Synergism | — | 8 | 2 | 1 | 0 | 5 | 30 | 1 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 100 | 70 | 80 | 70 | 40 | 0 | 5 | 15 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 0 | 0 | 0 | 0 | 0 | 30 | 30 |
| Mefenpyr | 300 | 0 | 0 | 0 | 0 | 0 | 0 | 0 |
| 2-[(2,4-Di- | 100 + | 70 | 97 | 75 | 85 | 10 | 0 | 5 |
| chlorophenyl)- | 50 + | | | | | | | |
| methyl]-4,4- | 300 | | | | | | | |
| dimethyl-3- | | | | | | | | |
| isoxazolidinone | | | | | | | | |
| + | | | | | | | | |
| Cinmethylin + | | | | | | | | |
| Mefenpyr | | | | | | | | |
| Expected | — | 70 | 80 | 20 | 40 | 0 | 34 | 41 |
| according to | | | | | | | | |
| COLBY | | | | | | | | |
| Synergism | — | 0 | 17 | 55 | 45 | 10 | −34 | −36 |

TABLE 15

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 100 | 60 | 60 | 70 | 75 | 50 | 20 | 40 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 80 | 70 | 90 | 100 | 0 | 50 | 65 |
| Mefenpyr | 100 | 0 | 0 | 0 | 0 | 0 | 0 | 0 |
| 2-[(2,4-Di- | 100 + | 99 | 95 | 95 | 99 | 60 | 90 | 80 |
| chlorophenyl)- | 50 + | | | | | | | |
| methyl]-4,4- | 100 | | | | | | | |
| dimethyl-3- | | | | | | | | |
| isoxazolidinone | | | | | | | | |
| + | | | | | | | | |
| Cinmethylin + | | | | | | | | |
| Mefenpyr | | | | | | | | |
| Expected | — | 92 | 88 | 97 | 100 | 50 | 60 | 79 |
| according to | | | | | | | | |
| COLBY | | | | | | | | |
| Synergism | — | 7 | 7 | −2 | −1 | 10 | 30 | 1 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 100 | 70 | 80 | 20 | 40 | 0 | 5 | 15 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 0 | 0 | 0 | 0 | 0 | 30 | 30 |
| Mefenpyr | 100 | 0 | 0 | 0 | 0 | 0 | 0 | 0 |
| 2-[(2,4-Di- | 100 + | 99 | 97 | 75 | 90 | 5 | 5 | 10 |
| chlorophenyl)- | 50 + | | | | | | | |
| methyl]-4,4- | 100 | | | | | | | |
| dimethyl-3- | | | | | | | | |
| isoxazolidinone | | | | | | | | |
| + | | | | | | | | |
| Cinmethylin + | | | | | | | | |
| Mefenpyr | | | | | | | | |
| Expected | — | 70 | 80 | 20 | 40 | 0 | 34 | 41 |
| according to | | | | | | | | |
| COLBY | | | | | | | | |
| Synergism | — | 29 | 17 | 55 | 50 | 5 | −29 | −31 |

TABLE 16

| | Dose | | | | | | | |
|---|---|---|---|---|---|---|---|---|
| | in g | ALOMY | ALOMY | LOLRI | LOLRI | | | |
| | AS/ha | sensitive | resistant | sensitive | resistant | AVEFA | BROST | SORHA |
| 2-[(2,4-Di- | 100 | 60 | 60 | 70 | 75 | 50 | 20 | 40 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 80 | 70 | 90 | 100 | 0 | 50 | 65 |
| Mefenpyr | 10 | 0 | 0 | 0 | 0 | 0 | 0 | 0 |
| 2-[(2,4-Di- | 100 + | 100 | 100 | 100 | 100 | 60 | 70 | 98 |
| chlorophenyl)- | 50 + | | | | | | | |
| methyl]-4,4- | 10 | | | | | | | |
| dimethyl-3- | | | | | | | | |
| isoxazolidinone | | | | | | | | |
| + | | | | | | | | |
| Cinmethylin + | | | | | | | | |
| Mefenpyr | | | | | | | | |
| Expected | — | 92 | 88 | 97 | 100 | 50 | 60 | 79 |
| according to | | | | | | | | |
| COLBY | | | | | | | | |
| Synergism | — | 8 | 12 | 3 | 0 | 10 | 10 | 19 |
| | Dose | | | | | | | |
| | in g | | | | | | | |
| | AS/ha | CENCY | VERHE | EMEAU | RAPRA | BRSNW | TRZAS | HORVS |
| 2-[(2,4-Di- | 100 | 70 | 80 | 20 | 40 | 0 | 5 | 15 |
| chlorophenyl)- | | | | | | | | |
| methyl]-4,4- | | | | | | | | |
| dimethyl-3- | | | | | | | | |
| isoxazolidinone | | | | | | | | |
| Cinmethylin | 50 | 0 | 0 | 0 | 0 | 0 | 30 | 30 |
| Mefenpyr | 10 | 0 | 0 | 0 | 0 | 0 | 0 | 0 |
| 2-[(2,4-Di- | 100 + | 93 | 97 | 75 | 50 | 5 | 5 | 20 |
| chlorophenyl)- | 50 + | | | | | | | |
| methyl]-4,4- | 10 | | | | | | | |
| dimethyl-3- | | | | | | | | |
| isoxazolidinone | | | | | | | | |
| + | | | | | | | | |
| Cinmethylin + | | | | | | | | |
| Mefenpyr | | | | | | | | |
| Expected | — | 70 | 80 | 20 | 40 | 0 | 34 | 41 |
| according to | | | | | | | | |
| COLBY | | | | | | | | |
| Synergism | — | 23 | 17 | 55 | 10 | 5 | −29 | −21 |

1. A herbicidal mixture, comprising herbicidal components
i) 2-[(2,4-dichlorophenyl)methyl]-4,4-dimethyl-3-isoxazolidinone and
ii) cinmethylin.

2. The herbicidal mixture according to claim 1, comprising at least one further herbicide of group I:
acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-6-(4-chloro-2-fluoro-3-methylphenyl)-5-fluoropyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, chiorsulfuron, cinidon, cinidon-ethyl, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyrimorate, cyclosulfamuron, cycloxydim, cyhalofop, cyhalofop-butyl, cyprazine, 2,4-D, 2,4-D-butotyl, -butyl, -dimethylammonium, -diolamine, -ethyl, -2-ethylhexyl, -isobutyl, -isooctyl, -isopropylammonium, -potassium, -triisopropanolammonium and -trolamine, 2,4-DB, 2,4-DB-butyl, -dimethylammonium, -isooctyl, -potassium and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, dimetrasulfuron, dinitramine, dinoterb, diphenamid, diquat, diquat dibromide, dithiopyr, diuron, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, F-5231, i.e. N-[2-chloro-4-fluoro-5-[4-(3-fluoropropyl)-4,5-dihydro-5-oxo-1H-tetrazol-1-yl]phenyl]ethansulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium and -trimesium, H-9201, i.e. O-(2,4-dimethyl-6-nitrophenyl) O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium and -sodium, MCPB, MCPB-methyl, -ethyl and -sodium, mecoprop, mecoprop-sodium and -butotyl, mecoprop-P, mecoprop-P-butotyl, -dimethylammonium, -2-ethylhexyl and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinate, monolinuron, monosulfuron, monosulfuron-ester, MT-5950, i.e. N-[3-chloro-4-(1-methylethyl)phenyl]-2-methylpentanamide, NGGC-011, napropamide, NC-310, i.e. 4-(2,4-dichlorobenzoyl)-1-methyl-5-benzyloxypyrazole, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), prazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, prithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazinc, simetryn, SL-261, sulcotrion, sulfentrazone, sulfometuron, sulfomturon-methyl, sulfosulfuron, SYN-523, SYP-249, i.e. 1-ethoxy-3-methyl-1-oxobut-3-en-2-vl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trifluoroacetic acid), TCA-sodium, tebuthiuron, tefutyltrione, tembotrione, tepraloxydim, terbacil, terbucarb, terbumeton, terbuthylazin, terbutryn, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trictazine, trifloxysulfuron, trifloxysulfuron-sodium, trifludimoxazin, trifluralin, triflusulfuron, triflusulfuron-methyl, tritosulfuron, urea sulfate, vernolate, XDE-848, ZJ-0862, i.e. 3,4-dichloro-N-{2-[(4,6-dimethoxypyrimidin-2-yl)oxy]benzyl}aniline, and also the following compounds:

[chemical structure]

3. The herbicidal mixture according to claim 1, comprising at least one safener, where the mixture permits an application rate that is 5-2000 g AS/ha, optionally 10-500 g AS/ha and optionally 10-300 g AS/ha.

4. The herbicidal mixture according to claim 1, comprising at least one safener of the group consisting of: cloquintocet-mexyl, cyprosulfamide, isoxadifen-ethyl and mefenpyr-diethyl.

5. The herbicidal mixture according to claim 1, wherein the herbicide components, with respect to one another, are present in the weight ratio stated below:
(range component i):(range component ii)
(1-1000):(1-1000), optionally (1-100):(1-100), optionally (1-50):(1-50).

6. The herbicidal mixture according to claim 1, comprising the herbicide components being capable of an application rate stated below:
component i): 1-2000 g AS/ha, optionally 10-1000 g AS/ha, optionally 10-500 g AS/ha of 2-[(2,4-dichlorophenyl)methyl]-4,4-dimethyl-3-isoxazolidinone;
component ii): 1-2000 g AS/ha, optionally 10-1000 g AS/ha, optionally 10-500 g AS/ha of cinmethylin.

7. The herbicidal mixture according to claim 1, additionally comprising one or more additives and/or formulation auxiliaries customary in crop protection.

8. The herbicidal mixture according to claim 1, additionally comprising one or more further components from the group of agrochemical active compounds comprising insecticides and fungicides.

9. A method controlling unwanted vegetation which comprises applying the components i) and ii) of the herbicidal mixture, defined in claim 1, jointly or separately to one or more plants, plant parts, plant seeds and/or an area on which plants grow.

10. The method according to claim 9 for selective control of one or more harmful plants in one or more plant crops.

11. The method according to claim 9 in which the plant crops are genetically modified or have been obtained by mutation selection.

12. A product comprising a herbicidal mixture according to claim 1 for controlling one or more harmful plants.

13. A product comprising the herbicidal mixture according to claim 1 for controlling one or more herbicide-resistant harmful plants.
